(19) United States
(12) Patent Application Publication
(10) Pub. No.: US 2014/0180522 A1
(43) Pub. Date: Jun. 26, 2014

(54) HYBRID VEHICLE CONTROL DEVICE

(71) Applicants: Yukihiko Ideshio, Nisshin-shi (JP); Susumu Kojima, Susono-shi (JP); Naoki Nakanishi, Susono-shi (JP); Akihiro Sato, Nagoya-shi (JP)

(72) Inventors: Yukihiko Ideshio, Nisshin-shi (JP); Susumu Kojima, Susono-shi (JP); Naoki Nakanishi, Susono-shi (JP); Akihiro Sato, Nagoya-shi (JP)

(73) Assignee: TOYOTA JIDOSHA KABUSHIKI KAISHA, Toyota-shi, Aichi-ken (JP)

(21) Appl. No.: 14/238,116

(22) PCT Filed: Aug. 11, 2011
(86) PCT No.: PCT/JP2011/068389

§ 371 Date: Feb. 10, 2014

(51) Int. Cl. B60W 20/00; B60W 10/06; B60W 10/08; B60W 10/02

(52) U.S. Cl. CPC B60W 20/10; B60W 10/02; B60W 10/06; B60W 10/08; Y10S 903/93
USPC 701/22; 180/65.265; 903/930

(57) ABSTRACT

A control device of a hybrid vehicle has an engine and an electric motor used as a drive source and an electric storage device supplying electric energy to the electric motor, the control device of a hybrid vehicle selectively performing electric motor running using the electric motor as the drive source and engine running using the engine as the drive source, the control device being configured to raise a rotation speed of the engine by directly injecting fuel into a cylinder of the engine and causing an explosion when the engine is started, and after raising the rotation speed of the engine, the electric motor assisting the raising of the rotation speed of the engine, the control device including a clutch mechanism disposed between the engine and the electric motor, the clutch mechanism separating the engine and the electric motor from each other during the electric motor running, after raising the rotation speed of the engine, the electric motor assisting the raising of the rotation speed of the engine via the clutch mechanism to provide a start assist, the control device being configured to synchronize a rotation speed of the clutch mechanism after the start of the engine is completed, and after the synchronization is completed, the clutch mechanism being engaged.

### TECHNICAL FIELD

The present invention relates to a control device of a hybrid vehicle including a clutch in a power transmission path between an engine and an electric motor and particularly to a technique of expanding an electric motor running range for running with the electric motor used as a drive force source so as to improve fuel efficiency.

### BACKGROUND ART

One type of hybrid vehicle is known with a drive device of a hybrid vehicle including a clutch in a power transmission path between an engine and an electric motor. This hybrid vehicle can selectively use at least one of the engine and the electric motor as a drive source for running. In general, during low-vehicle-speed and low-load running of the vehicle, the clutch is released to select the electric motor running using only the electric motor as the drive source with the engine disconnected and, during high-load running and high-vehicle-speed running of the vehicle, the clutch is engaged to select the engine running using at least the engine as the drive source. For example, this corresponds to hybrid vehicles described in Patent Documents 1 and 2.

According to these vehicles, on a lower load side preventing acquisition of sufficient engine efficiency, electric energy stored in an electric storage device can be used for performing the electric motor running so as to improve a fuel efficiency of the vehicle and, therefore, a proportion of the electric motor running is desirably increased as much as possible.

### PRIOR ART DOCUMENTS

### Patent Documents

Patent Document 1: Japanese Laid-Open Patent Publication No. 11-082260
Patent Document 2: Japanese Laid-Open Patent Publication No. 2004-204963

### SUMMARY OF THE INVENTION

### Problem to be Solved by the Invention

Although the electric motor running of the hybrid vehicle is implemented by consuming electric energy stored in the electric storage device, the electric storage device must constantly secure electric energy for starting the engine by using the electric motor. As a result, a proportion of electric energy used for the electric motor running is set to be smaller by the engine start energy and, therefore, an electric motor running range is made smaller by a portion corresponding to the electric energy for the engine start, preventing sufficient improvement in vehicle fuel efficiency.

The present invention was conceived in view of the situations and it is therefore an object of the present invention to provide a control device of a hybrid vehicle capable of reducing electric energy constantly secured in an electric storage device for starting an engine as small as possible to expand an electric motor running range.

### Means for Solving the Problem

To achieve the object, the present invention provides a control device of a hybrid vehicle having an engine and an electric motor used as a drive source and an electric storage device supplying electric energy to the electric motor, the control device of a hybrid vehicle selectively performing electric motor running using the electric motor as the drive source and engine running using the engine as the drive source, wherein when the engine is started, a rotation speed of the engine is raised by directly injecting fuel into a cylinder of the engine and causing an explosion.

### Effects of the Invention

Consequently, since when the engine is started, a rotation speed of the engine is raised by directly injecting fuel into a cylinder of the engine and causing an explosion, this significantly reduces necessity to constantly secure in the electric storage device the electric energy for starting the engine by using the electric motor. Therefore, since it is no longer necessary to set a proportion of the electric energy usable for the electric motor running smaller by the electric energy required for the start of the engine, the electric motor running range does not need to be reduced by a portion corresponding to the electric energy for the engine start, and the electric motor running range can be expanded and the fuel efficiency of the vehicle can accordingly be improved.

Preferably, after raising the rotation speed of the engine, the electric motor assists the raising of the rotation speed of the engine. Consequently, even if the startability of the engine is reduced such that the raising of rotation speed of the engine is not smoothly performed, the engine can certainly be started.

More preferably, if a clutch mechanism is included and interposed between the engine and the electric motor to disconnect the engine and the electric motor from each other during the electric motor running, when the engine is started, the clutch mechanism is disconnected and the rotation speed of the engine is raised by using only the explosion of the engine. Consequently, in a hybrid vehicle including the clutch mechanism, since the rotation speed of the engine can be raised by directly injecting fuel into a cylinder in the expansion stroke out of the cylinders disposed in the engine and igniting the fuel to cause an explosion without using the electric energy when the engine is started, the electric motor running range does not need to be reduced by a portion corresponding to the electric energy for the engine start and the electric motor running range can accordingly be expanded, and this also advantageously eliminates necessity of control of temporarily increasing the output of the electric motor so as to compensate a temporal reduction in the drive force associated with the engagement of the clutch, which is necessary when the engine is started by using the electric motor during the electric motor running.

Preferably, when the clutch mechanism is included and interposed between the engine and the electric motor to disconnect the engine and the electric motor from each other during the electric motor running, after raising the rotation speed of the engine, the electric motor assists the raising of the rotation speed of the engine via the clutch mechanism to provide a start assist. Consequently, if the startability of the engine is reduced such that the raising of rotation speed of the engine is not smoothly performed in the hybrid vehicle including the clutch mechanism, the engine can certainly be started. When the engine is started during running, the rotation speed of the engine is raised and then assisted by the clutch mechanism, the torque assist necessary for the engine start can be provided and a shock of the vehicle is preferably prevented from occurring due to a gap of the timing of the assist by the electric motor.

Preferably, whether the start assist is provided is determined based on at least one of a water temperature of the engine, a stop position of the engine, an exhaust counter flow at the stop of the engine, and a fuel pressure of the engine. Therefore, if reduced engine startability is determined, such as when the engine water temperature is reduced to a level affecting the engine start, when the engine stop position is within an angle range preventing acquisition of a sufficient explosion force, when sufficient explosion is hardly expected at the time of start due to presence of an exhaust counter flow at the time of engine stop, when sufficient fuel injection is hardly expected at the time of engine start due to high engine fuel pressure, etc., the start assist is provided. Consequently, the engine can certainly be started even if the startability of the engine is reduced such that the raising of rotation speed of the engine is not smoothly performed.

Preferably, after the start of the engine is completed, a rotation speed of the clutch mechanism is synchronized, and after the synchronization is completed, the clutch mechanism is engaged. Consequently, an engagement shock is prevented from occurring at the time of engagement of the clutch mechanism.

Preferably, when the engine is started, if an acceleration opening degree is equal to or greater than a preset high opening degree determination value, if a change rate of the acceleration opening degree is equal to or greater than a preset rapid operation determination value, if a temperature of catalyst purifying exhaust gas of the engine is equal to or less than a preset activation temperature determination value, or if a rotation speed of the electric motor is equal to or less than a preset start determination value, the start assist is preferentially provided. If the start of the engine is prioritized over the fuel efficiency of the vehicle as described above, the engine can advantageously rapidly be started.

### BRIEF DESCRIPTION OF THE DRAWINGS

FIG. 1 is a conceptual diagram of a configuration of a drive system according to a drive device of a hybrid vehicle that is one embodiment of the present invention.

FIG. 2 depicts a relationship stored in advance of an electric motor (EV) running range and an engine running range set in two-dimensional coordinates of a vehicle speed axis and a required drive force or an accelerator opening degree axis.

FIG. 3 is a functional block diagram for explaining a main portion of a control function included in the electronic control device of FIG. 1.

FIG. 4 is a flowchart for explaining a main portion of the engine start control in the electronic control device of FIG. 1.

### MODE FOR CARRYING OUT THE INVENTION

A preferred embodiment of the present invention will now be described in detail with reference to the drawings.

### Embodiment

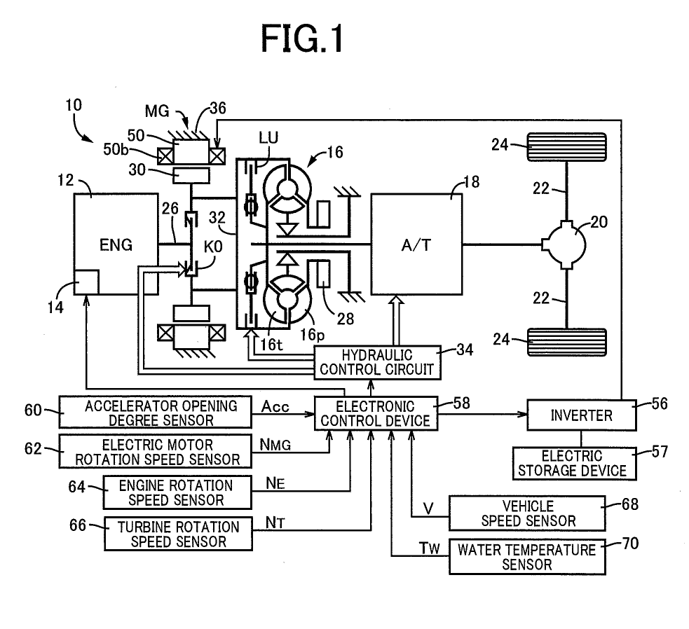

FIG. 1 is a conceptual diagram of a configuration of a drive system according to a drive device 10 of a hybrid vehicle that is one embodiment of the present invention. The drive device 10 depicted in FIG. 1 includes an engine 12 and an electric motor MG acting as drive sources and a drive force generated by the engine 12 and the electric motor MG is transmitted through each of a torque converter 16, an automatic transmission 18, a differential gear device 20, and a pair of left and right axles 22 to a pair of left and right drive wheels 24. Because of this configuration, the drive device 10 is driven by using at least one of the engine 12 and the electric motor MG as a drive source for running. Therefore, the drive device 10 selectively establishes any one of engine running using only the engine 12 as the drive source for running, EV running (motor running) using only the electric motor MG as the drive source for running, and hybrid running using the engine 12 and the electric motor MG as the drive sources for running.

The engine 12 is an internal combustion engine such as cylinder-injection gasoline and diesel engines in which fuel is directly injected into a combustion chamber, for example. To control driving (output torque) of the engine 12, an output control device 14 is disposed that includes a throttle actuator providing opening/closing control of an electronic throttle valve, a fuel injection device providing fuel injection control, and an ignition device providing ignition timing control. The output control device 14 controls the opening/closing of the electronic throttle valve with the throttle actuator for throttle control in accordance with instructions supplied from an electronic control device 58 described later, controls fuel injection by the fuel injection device for the fuel injection control, and controls timing of ignition by the ignition device for the ignition timing control, thereby providing output control of the engine 12.

The electric motor MG is a motor generator having functions of a motor (mover) generating a drive force and a generator (electric generator) generating a reactive force, and a power transmission path between the engine 12 and the electric motor MG is disposed with a clutch K0 controlling power transmission through the power transmission path depending on an engagement state. In particular, a crankshaft 26 is an output member of the engine 12 and is selectively coupled via the clutch K0 to a rotor 30 of the electric motor MG. The rotor 30 of the electric motor MG is coupled to a front cover 32 that is an input member of the torque converter 16.

The clutch K0 is, for example, a wet multiplate hydraulic friction engagement device subjected to engagement control by a hydraulic actuator and has an engagement state thereof controlled among engagement (complete engagement), slip engagement, and release (complete release) in accordance with an oil pressure supplied from a hydraulic control circuit 34. The engagement of the clutch K0 causes power transmission (connection) through a power transmission path between the crankshaft 26 and the front cover 32 while the release of the clutch K0 interrupts the power transmission through the power transmission path between the crankshaft 26 and the front cover 32. The slip engagement of the clutch K0 causes the power transmission corresponding to a transmission torque of the clutch K0 through the power transmission path between the crankshaft 26 and the front cover 32. The clutch K0 is preferably a constantly-closed (normally-closed) clutch engaged more closely when an oil pressure command from the electronic control device 58 described later indicates a lower oil pressure.

The automatic transmission 18 is a stepped automatic transmission in which any one of a plurality of predefined shift stages (gear ratios) is selectively established, for example, and is configured with a plurality of engagement elements for selecting the gear stages. For example, the automatic transmission 18 includes a plurality of hydraulic friction engagement devices such as multiplate clutches and brakes subjected to engagement control by hydraulic actuators and the plurality of the hydraulic friction engagement devices are selectively engaged or released in accordance with the oil pressure supplied from the hydraulic control circuit 34, thereby selectively establishing any one of a plurality of (e.g., first- to sixth-speed) forward shift stages (forward gear stages, forward running gear stages) or a backward shift stage (backward gear stage, backward running gear stage) in accordance with a combination of coupling states of the hydraulic friction engagement devices.

The crankshaft 26 has an output end portion, i.e., one end portion closer to the electric motor MG, coupled integrally with a clutch hub of the clutch K0 via a drive plate etc. not shown. A pump impeller 16p of the torque converter 16 is coupled to a mechanical hydraulic pump 28, and an oil pressure is generated by the mechanical hydraulic pump 28 in accordance with rotation of the pump impeller 16p and is supplied as an original pressure to the hydraulic control circuit 34.

Between the pump impeller 16p and a turbine impeller 16t of the torque converter 16, a lockup clutch LU is disposed for direct coupling so that the pump impeller 16p and the turbine impeller 16t are integrally rotated. The lockup clutch LU has an engagement state thereof controlled among engagement (complete engagement), slip engagement, and release (complete release) in accordance with the oil pressure supplied from the hydraulic control circuit 34. Therefore, the lockup clutch LU corresponds to a second clutch disposed in a power transmission path between the electric motor MG and the drive wheels 24 to control power transmission through the power transmission path depending on the engagement state.

The electric motor MG includes the rotor 30 supported rotatably around a shaft center of the torque converter 16 by a transmission case 36 and a stator 50 integrally fixed to the transmission case 36 on an outer circumferential side of the rotor 30. The rotor 30 is coupled to the front cover 32 via a transmitting member fixed integrally to the front cover 32 by welding, for example. The stator 50 includes a core that is a plurality of annular steel plates each stacked in the shaft center direction and integrally fixed to the transmission case 36, and a plurality of coils 50b annularly wound around a portion in a circumferential direction of an inner circumferential portion of the core and disposed serially in the circumferential direction.

The electric motor MG configured in this way is connected via an inverter 56 to an electric storage device 57 such as a battery and a capacitor, and a drive current supplied to the coils 50b is adjusted by controlling the inverter 56 by the electronic control device 58 described later, thereby controlling the drive of the electric motor MG In other words, the inverter 56 is controlled by the electronic control device 58, thereby increasing and decreasing the output torque of the electric motor MG Although the output torque from the electric motor MG is output only to the torque converter 16 while the clutch K0 is released (not engaged), a portion of the output torque is output to the torque converter 16 and the other portion is output to the engine 12 while the clutch K0 is engaged.

In the drive device 10, for example, when a shift is made from EV running using only the electric motor MG as the drive source for running to engine running or hybrid running using the engine 12 as the drive source, the engine 12 is started by engaging the clutch K0. In particular, by slip-engaging or completely engaging the clutch K0, the engine 12 is rotationally driven by a torque for engine start transmitted via the clutch K0 and, while an engine rotation speed N_{E} is consequently raised, engine ignition, fuel supply, etc., are controlled to start the engine 12. In this case, a compensation torque is generated by the electric motor MG to suppress generation of acceleration (deceleration G) in a vehicle longitudinal direction. Therefore, the engine 12 is started by rotationally rotating the engine 12 with the a torque acquired from explosion energy due to ignition and a torque acquired from engagement energy due to the clutch K0, i.e., an engine start torque transmitted through the clutch K0.

In the control system exemplarily illustrated in FIG. 1, the electronic control device 58 includes a so-called microcomputer including a CPU, a RAM, a ROM, and an input/output interface, and the CPU executes signal processes in accordance with programs stored in advance in the ROM while utilizing a temporary storage function of the RAM, thereby providing basic control such as the drive control of the engine 12, the drive control of the electric motor MG, the shift control of the automatic transmission 18, the engagement force control of the clutch K0, and the engagement control of the lockup clutch LU, along with various types of control such as engine start control of this embodiment described later.

The electronic control device 58 is supplied with various input signals detected by sensors disposed on the drive device 10. For example, the electronic control device 58 receives inputs of a signal indicative of an accelerator opening degree A_{CC} detected by an accelerator opening degree sensor 60, a signal indicative of a rotation speed (electric motor rotation speed) N_{MG} of the electric motor MG detected by an electric motor rotation speed sensor 62, a signal indicative of the rotation speed (engine rotation speed) N_{E} of the engine 12 or a rotation angular phase of the crankshaft 26 detected by an engine rotation speed sensor 64, a signal indicative of a rotation speed (turbine rotation speed) N_{T} of the turbine impeller 16t of the torque converter 16 detected by a turbine rotation speed sensor 66, a signal indicative of a vehicle speed V detected by a vehicle speed sensor 68, and a signal indicative of a cooling water temperature T_{W} of the engine 12 detected by a water temperature sensor 70. The rotation speed N_{MG} of the electric motor MG detected by the electric motor rotation speed sensor 62 is an input rotation speed of the torque converter 16 and corresponds to the rotation speed of the pump impeller 16p of the torque converter 16. The rotation speed N_{T} of the turbine impeller 16t detected by the turbine rotation speed sensor 66 is an output rotation speed of the torque converter 16 and corresponds to an input rotation speed of the automatic transmission 18.

The electronic control device 58 outputs various output signals to the devices disposed on the drive device 10. For example, the electronic control device 58 supplies to the portions a signal supplied to the output control device 14 of the engine 12 for the drive control of the engine 12, a signal supplied to the inverter 56 for the drive control of the electric motor MG, a signal supplied to a plurality of electromagnetic control valves in the hydraulic control circuit 34 for the shift control of the automatic transmission 18, and a signal supplied to the hydraulic control circuit 34 for the engagement control of the clutch K0.

The electronic control device 58 selects and performs, for example, an electric motor (EV) running mode using only the electric motor MG as the drive source for running by using electric energy from the electric storage device 57 with the engine 12 stopped at a relatively light load of the vehicle, an engine running mode using only the engine 12 as the drive source for running at a relatively high load of the vehicle, and an engine/electric motor running mode using both the engine 12 and the electric motor MG as the drive sources for running if a larger drive force is temporarily required at the time of rapid acceleration etc., as well as a regenerative running mode using the electric motor MG for deceleration or braking through regeneration (electric generation) and storing regenerated electric energy into the electric storage device 57 during deceleration running of the vehicle, in accordance with a preset vehicle state.

In the electric motor (EV) running mode, the drive of the engine 12 is stopped and the clutch K0 is released (completely released). As a result, since the power transmission path between the engine 12 and the electric motor MG is interrupted, power is not transmitted from the engine 12 to the lockup clutch 16 side and, conversely, torque transmission is not performed from the lockup clutch 16 side to the engine 12. On the other hand, in the engine running mode or the engine/electric motor running mode, the engine 12 is operated and the clutch K0 is completely engaged. As a result, power is transmitted from the engine 12 to the lockup clutch 16 side through the power transmission path between the engine 12 and the electric motor MG and, conversely, torque transmission (engine braking) is performed from the lockup clutch 16 side to the engine 12.

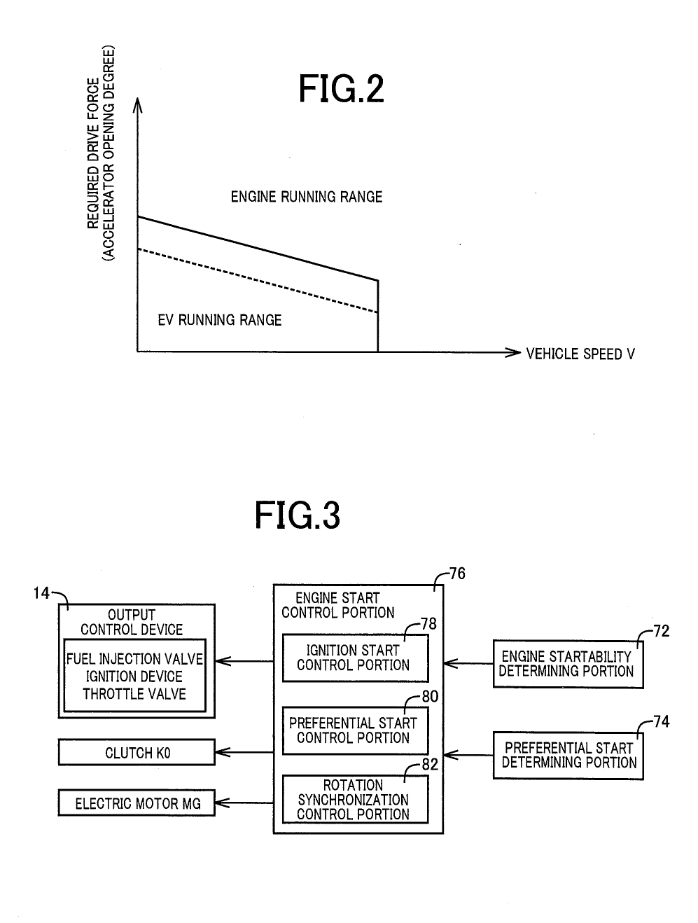

FIG. 2 depicts a relationship of an electric motor (EV) running range and an engine running range set in two-dimensional coordinates of a vehicle speed axis indicative of a vehicle speed V and an axis indicative of a required drive force or an accelerator opening degree, and is stored in the electronic control device 58 in advance. From the relationship depicted in FIG. 2, the electronic control device 58 determines the electric motor (EV) running range or the engine running range based on the actual vehicle speed V and the required drive force or the accelerator opening degree and selects the electric motor (EV) running mode or the engine running mode. For example, if a switchover from the electric motor (EV) running range to the engine running range is determined in association with an increase in the required drive force or the accelerator opening degree, the electronic control device 58 outputs an engine start command (engine start request) to start the engine 12. The engine start command output during vehicle stop or during electric motor (EV) running is output in association with a warm-up command of the engine 12, detection of reduction in a charge remaining amount SOC of the electric storage device, and actuation of an air conditioner regardless of the running range in other cases.

FIG. 3 is a functional block diagram for explaining a main portion of a control function included in the electronic control device 58, i.e., a main portion of control of starting the engine 12 in response to the engine start command. In FIG. 3, an engine startability determining portion 72 determines that the start of the engine 12 is easy, when all the conditions are satisfied, which are that the cooling water temperature T_{W} (degrees C.) of the engine 12 detected by the water temperature sensor 70 is equal to or greater than a preset determination value Ta; that a stop angle position (degrees) of the crankshaft 26 detected by the engine rotation speed sensor 64 is within a preset easy start angle range considered to facilitate the start in an ignition start described later, i.e., within an angle range not including angles near a top dead center and near a bottom dead center; that an exhaust counter flow into a cylinder does not occur due to returning of a crank angle CA at the stop of the engine 12; and that a pressure of fuel supplied to a fuel injection valve has a sufficiently high pressure value capable of fuel injection, for example, and determines that the start of the engine 12 is difficult if any of above is not satisfied.

A preferential start determining portion 74 determines preferential startability of the engine 12, i.e., whether the engine 12 needs to be started in preference to the ignition start, for example, based on that an accelerator opening degree θa (%) is equal to or greater than a preset high output operation amount determination value and/or that a change rate dθa/dt of the accelerator opening degree θa (%) is equal to or greater than a preset high acceleration operation determination value. These determinations are made so as to determine that the engine 12 must rapidly be started by using the electric motor MG in preference to starting the engine 12 without using the electric energy when a driver makes a high acceleration or high output request. The preferential start determining portion 74 determines the preferential startability of the engine 12, i.e., whether the engine 12 needs to be started in preference to the ignition start, for example, based on that a catalyst temperature (degrees C.) is equal to or less than a preset activity determination temperature. This determination is made so as to determine that the engine 12 must rapidly be started by using the electric motor MG to avoid a risk of directly discharging exhaust gas in a deteriorating state from the engine 12 after the ignition start. The preferential start determining portion 74 determines the preferential startability of the engine 12, i.e., whether the engine 12 needs to be started in preference to the ignition start, for example, based on that the rotation speed N_{MG} (rpm) of the electric motor MG is lower than a preset rotation speed determination value. This determination is made so as to determine that the engine 12 must rapidly be started by using the electric motor MG to prevent a rotation speed N_{E} of the engine 12 after the ignition start from continuing a state in which an autonomous increase in rotation is difficult.

An engine start control portion 76 includes an ignition start control portion 78, a preferential start control portion 80, and a rotation synchronization control portion 82 and starts the engine 12 by using only the ignition start in response to the engine start command without allowing the electric motor MG to consume the electric energy in the normal case when the engine startability determining portion 72 affirms start easiness of the engine 12 and the preferential start determining portion 74 denies the preferential startability of the engine 12. However, if the engine startability determining portion 72 denies the start easiness of the engine 12 or the preferential start determining portion 74 affirms the preferential startability of the engine 12, instead of or in addition to the start of engine 12 by the ignition start, the engine start control portion 76 performs the engine ignition and the fuel supply via the output control device 14 and starts cranking of the engine 12 to rapidly raise the rotation of engine 12 by using the electric motor MG, thereby starting the engine 12 in preference to the ignition start. When the start of the engine 12 is completed, the engine start control portion 76 adjusts the rotation speed of the engine 12 by using, for example, throttle opening degree or ignition timing delay control of the output control device 14 so as to synchronize the clutch K0 and allows the clutch K0 to engage when the synchronization is completed.

The ignition start control portion 78 detects a cylinder in an expansion stroke out of cylinders of the engine 12 during stop of rotation based on the crank angle CA, for example, and repeatedly generates a torque by directly injecting fuel into the cylinder and igniting the fuel to cause an explosion so that the rotation speed of the engine 12 is raised to a rotation speed enabling autonomous rotation or higher without using the assist torque of the electric motor MG using electric energy, i.e., without consuming the electric energy of the electric storage device, thereby starting the engine 12.

If the engine startability determining portion 72 denies the start easiness of the engine 12 or the preferential start determining portion 74 affirms the preferential startability of the engine 12, the preferential start control portion 80 raises the rotation speed of the engine 12 to a rotation speed enabling autonomous rotation or higher by using the electric motor MG to rapidly start the engine 12, instead of or in addition to the start of engine 12 by the ignition start.

When the rotation speed reaches a start determination rotation speed set in advance to a value higher than the rotation speed enabling autonomous rotation, for example, at about 800 rpm, and the start of the engine 12 is completed, the rotation synchronization control portion 82 uses, for example, the throttle opening degree or ignition timing delay control of the output control device 14 to adjust the rotation speed of the engine 12 so that the clutch K0 is synchronized, and allows the clutch K0 to engage when the synchronization is completed.

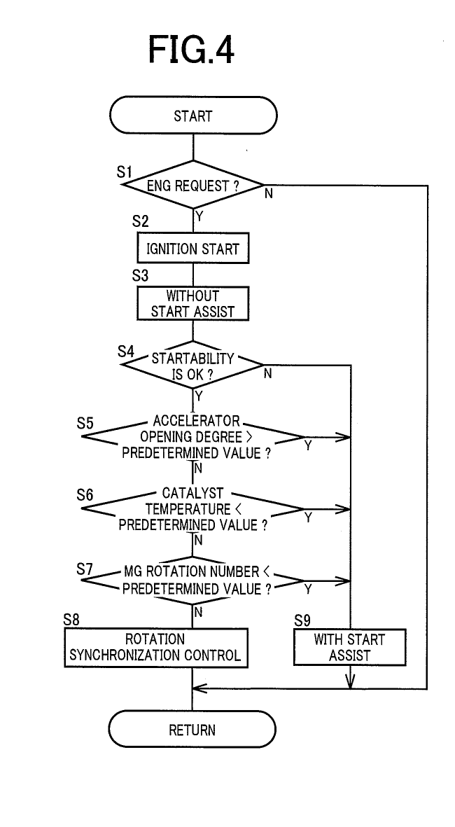

FIG. 4 is a flowchart for explaining a main portion of the engine start control operation by the electronic control device 58 and is repeatedly executed in a predetermined cycle.

First, at step (hereinafter, step will be omitted) S1, for example, it is determined whether the engine start command (engine start request) is issued in conjunction with the determination of a switchover from the electric motor (EV) running range to the engine running range associated with an increase in the required drive force or the accelerator opening degree, the warm-up command of the engine 12, the detection of reduction in the charge remaining amount SOC of the electric storage device, or the actuation of the air conditioner. If the determination of Si is negative, this routine is terminated.

If the determination of S1 is affirmative, at S2 and S3 corresponding to the ignition start control portion 78, a torque is repeatedly generated by directly injecting fuel into a cylinder in the expansion stroke out of the cylinders disposed in the engine 12 and igniting the fuel to cause an explosion so that the rotation speed of the engine 12 is raised to a rotation speed enabling autonomous rotation or higher, thereby initiating the start of the engine 12. In this period, the start-time assist torque of the electric motor MG using electric energy is not used, and the start of the engine 12 is initiated by using only the ignition start without consuming the electric energy of the electric storage device.

At S4 corresponding to the engine startability determining portion 72, the start easiness of the engine 12 is determined based on satisfaction of all the conditions, which are that the cooling water temperature T_{W} (degrees C.) of the engine 12 detected by the water temperature sensor 70 is equal to or greater than the preset determination value Ta; that a stop angle position (degrees) of the crankshaft 26 detected by the engine rotation speed sensor 64 is within the preset easy start angle range considered to facilitate the start in the ignition start described later, i.e., within an angle range not including angles near a top dead center and near a bottom dead center; that an exhaust counter flow into a cylinder does not occur at the stop of the engine 12; and that a pressure of fuel supplied to the fuel injection valve has a sufficiently high pressure value capable of fuel injection, for example.

If the determination of S4 is affirmative, at S5, S6, and S7 corresponding to the preferential start determining portion 74, it is determined whether the engine 12 is started in preference to the ignition start. In particular, at S5, the preference startability is determined based on that the accelerator opening degree θa (%) is equal to or greater than the preset high output operation amount determination value and/or that the change rate dθa/dt of the accelerator opening degree θa (%) is equal to or greater than the preset high acceleration operation determination value. If the determination of S5 is negative, at S6, the preference startability is determined based on that the catalyst temperature (degrees C.) is equal to or less than the preset activity determination temperature. If the determination at S6 is negative, at S7, the preference startability is determined based on that the rotation speed N_{MG} (rpm) of the electric motor MG is lower than the preset rotation speed determination value.

If the determination of S4 is affirmative and all the determinations of S5 to S7 are negative, the ignition start is continued and, at S8 corresponding to the synchronization control portion 82, if the engine rotation speed N_{E} reaches a preset start completion determination value and it is determined that the start of the engine 12 by the ignition start is completed, the rotation speed of the engine 12 is adjusted by using, for example, the throttle opening degree or ignition timing delay control of the output control device 14 so as to synchronize the clutch K0 and, when the synchronization is completed, the clutch K0 is engaged.

However, if the determination of S4 is negative or if the determination of any of S5 to S7 is affirmative, at S9 corresponding to the preferential start control portion 80, the rotation speed of the engine 12 is immediately raised to a rotation speed enabling autonomous rotation or higher by using the electric motor MG and the engine 12 is started. As a result, the rotation speed of the engine 12 is raised to a rotation speed enabling autonomous rotation or higher by using the electric motor MG to rapidly start the engine 12, instead of or in addition to the start of engine 12 by the ignition start.

As described above, according to the electronic control device 58 of this embodiment, when the engine 12 is started, the rotation speed of the engine 12 is raised by directly injecting fuel into a cylinder in the expansion stroke out of the cylinders disposed in the engine 12 and igniting the fuel to cause an explosion without using the electric energy stored in the electric storage device 57 and this significantly reduces necessity to constantly secure in the electric storage device the electric energy for starting the engine 12 by using the electric motor MG. Therefore, since it is no longer necessary to set a proportion of the electric energy usable for the electric motor running smaller by the electric energy required for the start of the engine 12, the electric motor running range does not need to be reduced by a portion corresponding to the electric energy for the engine start as indicated by a broken line in FIG. 2, and the electric motor running range can be expanded as indicated by a solid line of FIG. 2 and the fuel efficiency of the vehicle can accordingly be improved.

According to the electronic control device 58 of this embodiment, since the raising of the rotation speed of the engine 12 is followed by performing a start assist helping the raising of the rotation speed of the engine 12 based on the electric energy using the electric motor MG if needed, even if the startability of the engine is reduced such that the raising of rotation speed of the engine 12 is not smoothly performed, the engine can certainly be started.

According to the electronic control device 58 of this embodiment, the clutch K0 (clutch mechanism) is included and interposed between the engine 12 and the electric motor MG to disconnect the engine 12 and the electric motor MG from each other during the electric motor running and when the engine 21 is started, the clutch K0 is disconnected and the rotation speed of the engine 12 is raised by using only the explosion of the engine 12. Therefore, since the rotation speed of the engine 12 can be raised by directly injecting fuel into a cylinder in the expansion stroke out of the cylinders disposed in the engine 12 and igniting the fuel to cause an explosion without using the electric energy when the engine 12 is started, the electric motor running range does not need to be reduced by a portion corresponding to the electric energy for the engine start and the electric motor running range can accordingly be expanded, and this also advantageously eliminates necessity of control of temporarily increasing the output of the electric motor MG so as to compensate a temporal reduction in the drive force associated with the engagement of the clutch K0, which is necessary when the engine 12 is started by using the electric motor MG during the electric motor running.

According to the electronic control device 58 of this embodiment, when the clutch K0 is included and interposed between the engine 12 and the electric motor MG to disconnect the engine 12 and the electric motor MG from each other during the electric motor running, after the raising of the rotation speed of the engine 12, the clutch K0 transmits the torque from the electric motor MG to provide the start assist helping the raising of the rotation speed of the engine 12. Therefore, if the startability of the engine is reduced such that the raising of rotation speed of the engine 12 is not smoothly performed in the hybrid vehicle including the clutch K0, the engine can certainly be started. When the engine is started during running, the rotation speed of the engine 12 is raised and then assisted by the clutch K0, the torque assist necessary for the engine start can be provided and a shock of the vehicle is preferably prevented from occurring due to a gap of the timing of the assist by the electric motor MG

According to the electronic control device 58 of this embodiment, since whether the start assist is provided is determined based on at least one of the water temperature of the engine 12, the stop position of the engine 12, the exhaust counter flow at the stop of the engine 12, and the fuel pressure of the engine 12, the engine can certainly be started even if the startability of the engine 12 is reduced such that the raising of rotation speed of the engine 12 is not smoothly performed.

According to the electronic control device 58 of this embodiment, since the rotation speed of the clutch K0 is synchronized after the start of the engine 12 is completed and the clutch K0 is engaged after the synchronization is completed, an engagement shock is prevented from occurring at the time of engagement of the clutch K0.

According to the electronic control device 58 of this embodiment, when the engine 12 is started, if an acceleration opening degree is equal to or greater than a preset high opening degree determination value, if a change rate of the acceleration opening degree is equal to or greater than a preset rapid operation determination value, if a temperature of catalyst purifying exhaust gas of the engine is equal to or less than a preset activation temperature determination value, or if the rotation speed of the electric motor is equal to or less than a preset start determination value, the start assist is preferentially provided and, therefore, if the start of the engine 12 is prioritized over the fuel efficiency of the vehicle, the engine 12 can advantageously rapidly be started.

Although the preferred embodiment of the present invention has been described in detail with reference to the drawings, the present invention is not limited thereto and is implemented in other different forms.

For example, although the hybrid vehicle disposed with the clutch K0 in the power transmission path between the engine 12 and the motor generator MG has been described in the embodiment, the vehicle may be a so-called dual motor hybrid vehicle having an engine coupled to a first rotating element of a planetary gear type power distribution device, a first electric motor coupled to a second rotating element of the power distribution device, and a second electric motor coupled to a third rotating element of the power distribution device. In the dual motor hybrid vehicle, for example, the first electric motor is put into an idling state to perform the ignition start of the engine and the start assist is provided by the first electric motor.

Although the clutch K0 etc., disposed in the power transmission path between the engine 12 and the motor generator MG are hydraulic friction engagement devices having an engagement state hydraulically controlled in the embodiment, for example, an electromagnetic clutch or a magnetic particle clutch having an engagement state electromagnetically controlled may be disposed in the power transmission path between the engine 12 and the motor generator MG. Therefore, the present invention may widely be applied to hybrid vehicles with a clutch included in a power transmission path between an engine and a motor generator and controlling power transmission through the power transmission path.

Although the present invention is applied to the hybrid vehicle 10 including the stepped automatic transmission 18 including a plurality of the hydraulic friction engagement devices in the example described in the embodiment, the automatic transmission 18 may not necessarily be disposed. For example, the present invention is preferably applied to a hybrid vehicle including a CVT such as a belt type continuously variable transmission and a toroidal continuously variable transmission as the automatic transmission instead of the automatic transmission 18. The present invention may also be applied to a hybrid vehicle in a form having a mutual electric path between multiple electric motors allowing the multiple electric motors to act as an electric continuously variable transmission.

In the embodiment, when the engine 12 is started, if the raising of the rotation speed of the engine 12 is assisted by using the electric motor MG, not only is the lockup clutch LU released, but also the friction engagement device in the automatic transmission 18 may be released to release the power transmission path therein.

Although not exemplarily illustrated one by one, the present invention is implemented with various modifications applied without departing from the spirit thereof

### Nomenclature of Elements

10: drive device 12: engine 14: output control device 57: electric storage device 58: electronic control device 72: engine startability determining portion 74: preferential start determining portion 76: engine start control portion 78: ignition start control portion 80: preferential start control portion 82: rotation synchronization control portion K0: clutch (clutch mechanism) MG: electric motor

1. A control device of a hybrid vehicle having an engine and an electric motor used as a drive source and an electric storage device supplying electric energy to the electric motor, the control device of a hybrid vehicle selectively performing electric motor running using the electric motor as the drive source and engine running using the engine as the drive source, the control device being configured to raise a rotation speed of the engine by directly injecting fuel into a cylinder of the engine and causing an explosion when the engine is started, and after raising the rotation speed of the engine, the electric motor assisting the raising of the rotation speed of the engine,
the control device including a clutch mechanism disposed between the engine and the electric motor, the clutch mechanism separating the engine and the electric motor from each other during the electric motor running,
after raising the rotation speed of the engine, the electric motor assisting the raising of the rotation speed of the engine via the clutch mechanism to provide a start assist,
the control device being configured to synchronize a rotation speed of the clutch mechanism after the start of the engine is completed, and after the synchronization is completed, the clutch mechanism being engaged.

2. (canceled)

3. The control device of a hybrid vehicle of claim 1, including a clutch mechanism disposed between the engine and the electric motor, the clutch mechanism separating the engine and the electric motor from each other during the electric motor running, wherein
when the engine is started, the rotation speed of the engine is raised by using only the explosion of the engine with the clutch mechanism disconnected.

4. (canceled)

5. The control device of a hybrid vehicle of claim 1, wherein whether the start assist is provided is determined based on at least one of a water temperature of the engine, a stop position of the engine, an exhaust counter flow at the stop of the engine, and a fuel pressure of the engine.

6. (canceled)

7. The control device of a hybrid vehicle of claim 1, wherein when the engine is started, if an acceleration opening degree is equal to or greater than a preset high opening degree determination value, if a change rate of the acceleration opening degree is equal to or greater than a preset rapid operation determination value, if a temperature of catalyst purifying exhaust gas of the engine is equal to or less than a preset activation temperature determination value, or if a rotation speed of the electric motor is equal to or less than a preset start determination value, the start assist is preferentially provided.
